(19) United States
(12) Patent Application Publication
(10) Pub. No.: US 2024/0385945 A1
(43) Pub. Date: Nov. 21, 2024

(54) CODE FIXING METHOD AND APPARATUS, AND DEVICE AND MEDIUM

(71) Applicant: Beijing Zitiao Network Technology Co., Ltd., Beijing (CN)

(72) Inventor: Junyu Yue, Beijing (CN)

(21) Appl. No.: 18/665,228

(22) Filed: May 15, 2024

(30) Foreign Application Priority Data
May 15, 2023 (CN) 202310544930.2

(51) Int. Cl. G06F 11/36

(52) U.S. Cl. CPC G06F 11/3624

(57) ABSTRACT

Embodiments of the present disclosure provide a code fixing method and apparatus, and a device and a medium. A specific implementation of the method includes: acquiring a modified line number corresponding to a modified code line in a first code file submitted; according to an encoding issue existing in the code line corresponding to the modified line number, fix a code in the first code file with the identity of a current submitter of the first code file, and acquiring a fixed line number corresponding to the code fixed; determining whether the fixed line number is included in the modified line number; and in response to determining that the fixed line number is not included in the modified line number, undoing the code fixing for the fixed line number. By using the method, the code in the code lines in the code file can be only fixed, thereby avoiding the problem in which the entire code file is fixed in the existing code fixing solution, resulting in an error in the information of an actual modifier of a part of code lines, thus pointing to an incorrect modifier in subsequent tracking of the part of code lines.

### CROSS-REFERENCE TO RELATED APPLICATION(S)

This application claims priority to Chinese Application No. 202310544930.2 filed May 15, 2023, the disclosure of which is incorporated herein by reference in its entity.

### FIELD

Embodiments of the present disclosure relate to the technical field of code inspection and fixing, and in particular to a code fixing method and apparatus, and a device and a medium.

### BACKGROUND

An existing code fixing solution usually uses a code inspection tool to inspect codes in a code file, and then used a code fixing tool to fix an inspected code issue. However, an existing code inspection tool and an existing code fixing tool may only perform code inspection and fixing on the entire code file in general. Therefore, the existing code fixing solution has the following problems: the code is fixed according to the entire code file may cause a modifier of a part of code lines to be changed into another modifier other than an actual modifier, resulting in an error in tracking a part of code lines subsequently, that is, a problem of pointing to an incorrect modifier.

Therefore, there is a need for a new code fixing method.

### SUMMARY

Embodiments of the present disclosure describe a code fixing method and apparatus, a device and a medium.

According to a first aspect, provided is a code fixing method, including: acquiring a modified line number corresponding to a modified code line in a first code file submitted; determining an encoding issue existing in the code line corresponding to the modified line number, according to the encoding issue, fix a code in the first code file with an identity of a current submitter of the first code file, and acquiring a fixed line number corresponding to the code fixed; and determining whether the fixed line number is included in the modified line number; and in response to determining that the fixed line number is not included in the modified line number, undoing the code fixing for the fixed line number.

According to a second aspect, provided is a code fixing method, including: acquiring a submitter corresponding to a target modification in each code line in a second code file; determining an encoding issue existing in a code line submitted by the submitter; according to the encoding issue, fixing a code in the second code file with an identity of the submitter, and acquiring a fixed line number corresponding to the code fixed; and determining whether the fixed line number is included in a modified line number corresponding to the code line submitted by the submitter; and in response to determining that the fixed line number is not included in the modified line number, undoing the code fixing for the fixed line number.

According to a third aspect, provided is a code fixing apparatus, including: a first acquisition unit, configured to acquire a modified line number corresponding to a modified code line in a first code file submitted; a first fixing unit, configured to according to an encoding issue existing in the code line corresponding to the modified line number, fix the code in the first code file with an identity of a current submitter of the first code file, and acquire a fixed line number corresponding to the code fixed; and a first undo unit, configured to determine whether the fixed line number is included in the modified line number; and in response to determining that the fixed line number is not included in the modified line number, undo fixing for the fixed line number.

According to a fourth aspect, provided is a code fixing apparatus, including: a second acquisition unit, configured to acquire a submitter corresponding to a target modification in each code line in a second code file; a second fixing unit, configured to determine an encoding issue existing in a code line submitted by the submitter; according to the encoding issue, fix a code in the second code file with an identity of the submitter, and acquire a fixed line number corresponding to the code fixed; and a second undo unit, configured to determine whether the fixed line number exists in a modified line number corresponding to each code line submitted by the submitter; and in response to determining that the fixed line number does not exist in the modified line number, undo fixing for the fixed line number.

According to a fifth aspect, provided is a computer-readable storage medium, storing a computer program thereon, wherein when the computer program is executed in a computer, the computer is caused to execute the methods in the first aspect and the second aspect.

According to a sixth aspect, provided is an electronic device, including a memory and a processor, wherein an executable code is stored in the memory, and the processor implements, when executing the executable code, the methods in the first aspect and the second aspect.

According to the embodiments of the present disclosure, provided are a code fixing method and apparatus, a device and a medium. The modified line number corresponding to the modified code line in the submitted code file is acquired, the code in the code file is fixed with the identity of the current submitter of the first code file for the encoding issue existing in the code line corresponding to the modified line number, and the fixed line number corresponding to the code fixed is acquired. Then, it is determined whether the fixed line number is included in the modified line number; and in response to determining that the fixed line number is not included in the modified line number, the code fixing for the fixed line number is undid. By using any one the method and apparatus, the storage medium and the electronic device, the code can be only fixed in the code lines in the code file, thereby avoiding the problem in which the entire code file is fixed in the existing code fixing solution, resulting in an error in the information of an actual modifier of a part of code lines, thus pointing to an incorrect modifier in subsequent tracking of the part of code lines.

### BRIEF DESCRIPTION OF THE DRAWINGS

FIG. 1 illustrates a schematic diagram of a code fixing solution;

FIG. 2 illustrates a schematic diagram of a code fixing method according to an embodiment of the present disclosure;

FIG. 3 illustrates a schematic flowchart of a code fixing method according to an embodiment of the present disclosure;

FIG. 4 illustrates a schematic flowchart of a code fixing method according to another embodiment of the present disclosure;

FIG. 5 illustrates a schematic block diagram of a code fixing apparatus according to an embodiment of the present disclosure;

FIG. 6 illustrates a schematic block diagram of a code fixing apparatus according to another embodiment of the present disclosure;

FIG. 7 illustrates a schematic structural diagram of an electronic device suitable for implementing embodiments of the present disclosure; and

FIG. 8 illustrates a schematic structural diagram of a storage medium suitable for implementing embodiments of the present disclosure.

### DETAILED DESCRIPTION OF EMBODIMENTS

The technical solutions provided in the present specification are further described in detail below in combination with the drawings and embodiments. It can be understood that the specific embodiments described herein are merely used for explaining related invention, rather than limiting the invention. In addition, it should be noted that, for ease of description, only parts related to the related invention are shown in the drawings. It should be noted that, in the case of no conflict, embodiments of the present disclosure and features in the embodiments may be combined with each other.

In the description of implementations of the present disclosure, the term “include” and similar terms should be understood as open-ended inclusion, that is, “including, but not limited to”. The term “based on” should be understood as “based, at least in part, on”. The term “one implementation” or “the implementation” should be understood as “at least one implementation”. The term “some implementations” should be understood as “at least some implementations”. Other explicit and implicit definitions may also be included below.

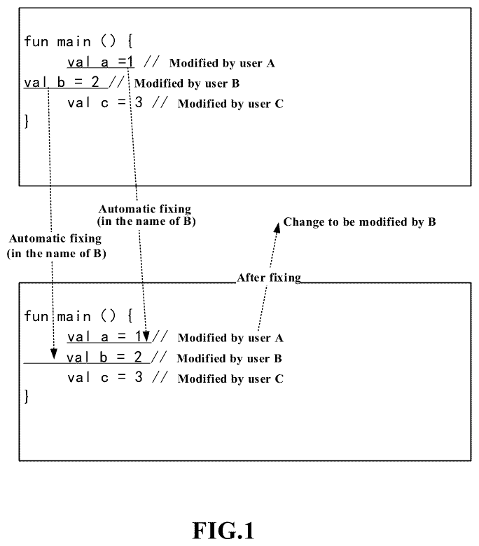

As described above, an existing code fixing solution usually uses a code inspection tool to inspect codes in a code file, and then uses a code fixing tool to fix an inspected code issue. However, an existing code inspection tool and an existing code fixing tool may only perform code inspection and fixing on the entire code file in general. However, the code fixed according to the entire code file may cause a modifier of a part of code lines to be changed into another modifier other than an actual modifier, resulting in an error in tracking a part of code lines subsequently, that is, a problem of pointing to an incorrect modifier. Specifically, for example, for a newly submitted code file, in response to determining that the code fixed according to the entire code file includes a modification for other code lines other than the currently submitted modified code line, a modifier of the other code lines (e.g., a submitter of a latest modification of the other code lines) becomes the submitter of the present code file, that is, the modifier of the other code lines under the responsibility (modification) of other persons in the code file also becomes the present submitter, resulting in an error in the information of the actual modifier in a tracking record of the other code lines, which in turn results in an error in tracking the other code lines subsequently, that is, a problem of pointing to an incorrect modifier. FIG. 1 illustrates a schematic diagram of a code fixing solution. As shown in FIG. 1, for example, the submitted code file includes a fun main ( ) function, in which a code actually modified in the present submission is a second line of codes in a function body of the function, that is, “val b=2”. After the code in the code file is fixed via an automatic code fixing tool, the display formats of the first line of codes and the second line of codes in the function body are actually corrected (or referred to as coverage). Since the automatic fixing is performed for the entire code file, after the fixing, a modifier corresponding to the first line of codes and the second line of codes in the function body becomes a submitter of the present code file, for example, for a user B. Therefore, the information of an actual submitter of a latest modification of the first line of codes (e.g., an actual responsible person of the first line of codes, e.g., a user A) will be lost. Accordingly, the subsequent tracking of the actual modifier for the first line of codes points to the user B, that is, points to an incorrect responsible person of the line of codes.

In addition, there is also a similar problem in the fixing of an existing code file, since code lines in the existing code file often belong to different authors (i.e., latest submitters). However, after the code file is fixed by using the automatic code fixing tool, for all the code fixed, the information of the latest submitter is changed into the information of a submitter (e.g., the user B) to which the automatic code fixing tool makes a reference. Thereafter, the tracking of the actual modifier for code lines, which are not submitted by the user A, in the code fixed will point to the user B, that is, point to the incorrect responsible person.

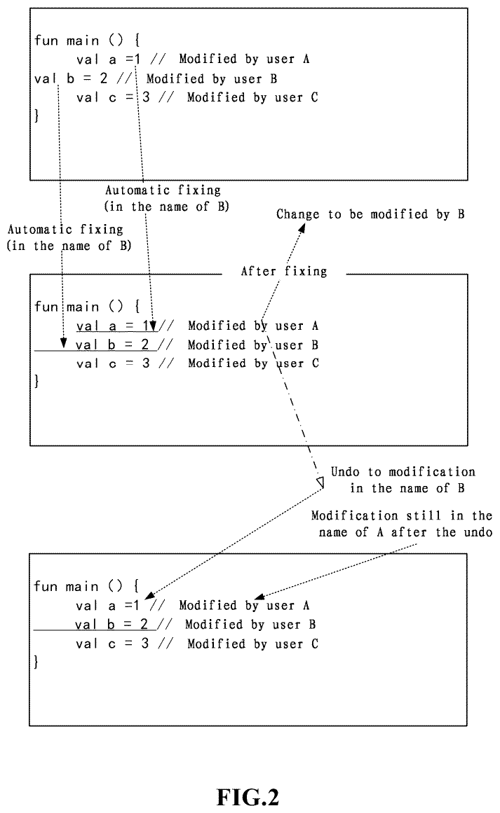

In order to solve the above technical problems, an embodiment of the present disclosure provides a code fixing method. In some embodiments, for example, for a submitted code file, after code fixing is performed on an encoding issue of the submitted code file, the code fixing for a code line that is not modified in the present submission is undid. FIG. 2 illustrates a schematic diagram of a code fixing method according to an embodiment of the present disclosure. As shown in FIG. 2, for example, the submitted code file includes a fun main ( ) function, in which the code actually modified in the present submission is a second line of codes in a function body of the function. After code in the code file is fixed via the automatic code fixing tool, the display formats of the first line of codes and the second line of codes in the function body are actually corrected, so that a modifier corresponding to the first line of codes and the second line of codes becomes a submitter of the present code file, for example, the user B. Since the actual modifier of the first line of codes is not the user B but, for example, the user A, the fixing for the first line of codes is undid, so that the modifier of the first line of codes is still the user A. In some other embodiments, for example, for the existing code file, the modifier of each code line of the existing code file may be collected, then the code in the code file is fixed for each modifier, and after the code in the code file is fixed for each modifier, the code fixing for a code line, which is not modified by the present modifier, in the present code fixing is undid. The method has the advantages of being not only able to fix the code in the submitted file or the existing file, but also being able to prevent the problem that after the code in the submitted file or the existing file is fixed, the information of the modifier of the code line in the submitted file or the existing file has an error, thereby preventing the problem in which the subsequent tracking of a code line having an error points to an incorrect modifier.

A detailed process of the method is further described below.

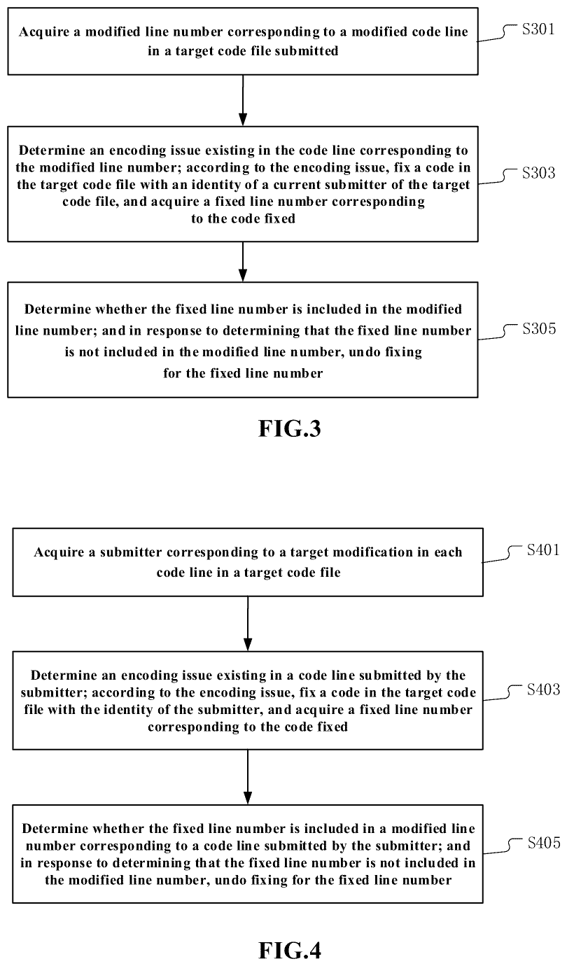

FIG. 3 illustrates a schematic flowchart of a code fixing method according to an embodiment of the present disclosure. As shown in FIG. 3, the method includes at least the following steps:
step S301, a modified line number corresponding to a modified code line in a first code file submitted is acquired.
step S303, an encoding issue existing in the code line corresponding to the modified line number is determined; according to the encoding issue, a code in the first code file is fixed with the identity of a current submitter of the first code file, and a fixed line number corresponding to the code fixed is acquired.
step S305, it is determined whether the fixed line number is included in the modified line number; and in response to determining that the fixed line number is not included in the modified line number, the code fixing for the fixed line number is undid.

First, in step S301, the modified line number corresponding to the modified code line in the first code file submitted is acquired. In this step, after receiving the submitted first code file (since the submitted code file is often accompanied by a code containing an increment, the submitted code file is also referred to as an incremental code file), the modified line number corresponding to the modified code line is determined. In alternative embodiments, codes in the first code file may be program codes of different software products or applications, or program codes used for different specific purposes. In one example, the codes are program source codes. In alternative embodiments, the codes in the first code file may also be program codes written based on different programming languages, which is not limited in the present specification. In one embodiment, the modified line number corresponding to the modified code line in the first code file submitted may be determined by a file difference instruction in a version control system (VCS). In alternative specific embodiments, the used version control systems may be different. Therefore, in alternative specific embodiments, the modified line number corresponding to the modified code line in the first code file submitted may be determined by different specific file difference instructions in different version control systems, which is not limited in the present specification.

Then, in step S303, the encoding issue existing in the code line corresponding to the modified line number is determined, according to the encoding issue, the code in the first code file is fixed with the identity of the current submitter of the first code file, and the fixed line number corresponding to the code fixed is acquired. In this step, the code in the first code file may be fixed according to the encoding issue existing in the code line corresponding to the modified line number, which is determined in step S301, and a line number (i.e., the fixed line number) of a code line actually corrected (covered) by the code fixing is acquired.

Specifically, in one embodiment, an issue line number corresponding to a code line having the encoding issue in the first code file may be determined; it is determined whether the issue line number is included in the modified line number; and in response to determining that the issue line number is included in the modified line number, according to the encoding issue existing in the code line corresponding to the issue line number, the code in the first code file is fixed with the identity of the current submitter of the first code file. After the above code fixing, the line number (i.e., the fixed line number) of the code line actually modified (covered) by the code fixing is determined. In one specific embodiment, the issue line number corresponding to the code line having the encoding issue in the first code file may be determined by a code inspection tool. In different specific embodiments, the code inspection tool may be different specific code inspection tools, for example, may be a static code analysis tool. In one specific embodiment, a Linter tool may be used, for example. In alternative embodiments, the encoding issue may be different specific encoding issues, which is not limited in the present specification. In one specific embodiment, for example, the encoding issue may be one or more of a code vulnerability issue, a code style issue, or a code structure issue.

The code in the first code file may be fixed by using an automatic code fixing tool. In alternative specific embodiments, the code in the first code file may be fixed by using different specific code fixing tools. In one embodiment, for example, the code in the first code file may be fixed by using a Formater tool.

In one embodiment, in response to determining that the issue line number is not included in the modified line number, the encoding issue existing in the code line corresponding to the issue line number may also be ignored. That is, the encoding issue involved in the non-present submission is ignored, so as to avoid the problem of losing the information of a real modifier of these code lines due to the fact that the code lines, which are not modified by the present submitter, are fixed in subsequent steps.

Thereafter, in step S305, it is determined whether the fixed line number is included in the modified line number; and in response to determining that the fixed line number is not included in the modified line number, the code fixing for the fixed line number is undid. In this step, in response to determining that code lines actually modified by the code fixing in step S303 include a code line that is not modified in the present submission, the code fixing for the code line that is not modified in the present submission is undid. Undo refers to fixing the state of the code line corresponding to the fixed line number to a state prior to the code fixing. For example, as shown in FIG. 2, the first line of codes in the function body of the fun main ( ) function is fixed to the state prior to the code fixing. Thus, the modifier of the first line of codes can be fixed to a correct modifier, that is, the user A.

In one embodiment, in response to determining that the fixed line number is included in the modified line number, it may indicate and identify that the code fixing aims at a code line modified by the current submitter in the code file. Thus, the code fixing for the fixed line number may be retained. In this way, the fixing of the code line modified by the correct modifier (the present submitter) can be retained.

FIG. 4 illustrates a schematic flowchart of a code fixing method according to another embodiment of the present disclosure. As shown in FIG. 4, the method includes at least the following steps:
Step S401, acquiring a submitter corresponding to a target modification in each code line in a second code file. In this step, the second code file may be an existing code file (or referred to as an inventory code file), and the submitter corresponding to the target modification in each code line in the second code file may be read. Since the current actual modifier of a code line may typically be a submitter of a latest modification of the code line, in one embodiment, the target modification may be the latest modification of each code line in the second code file.

Similar to the first code file in step S301, in alternative embodiments, codes in the second code file may also be program codes of different software products or applications, or program codes used for different specific purposes. In alternative embodiments, the codes in the second code file may also be program codes written based on different programming languages, which is not limited in the present specification.
Step S403, an encoding issue existing in a code line submitted by the submitter is determined; according to the encoding issue, the code in the second code file is fixed with the identity of the submitter, and a fixed line number corresponding to the code fixed is acquired.

In this step, the encoding issue existing in the code line submitted by the submitter, which is determined in step S401, may be collected. For the encoding issue, the code in the second code file is fixed with the identity of the submitter. After the code fixing, the fixed line number corresponding to the code fixed is acquired. The specific manner of determining the encoding issue existing in the code line and a specific manner of performing code fixing are similar to similar operations in step S303, and for details, reference may be made to the description of step S303, thus details are not repeated herein again.
Step S405, it is determined whether the fixed line number is included in a modified line number corresponding to the code line submitted by the submitter; and in response to determining that the fixed line number is not included in the modified line number, the code fixing for the fixed line number is undid. In this step, in response to determining that code lines actually corrected by the code fixing in step S403 include a code line that is not modified by the submitter, the code fixing for the code line that is not modified by the submitter is undid.

Since there may be a plurality of code lines in the second code file, there may be a plurality of submitters determined in step S401. Therefore, in one embodiment, for any submitter among the plurality of submitters, the encoding issue existing in the code line submitted by the any submitter may be determined; and for the encoding issue, the code in the second code file is fixed with the identity of the any submitter, and the fixed line number corresponding to the code fixed is acquired. Then, it is determined whether the fixed line number exists in the modified line number corresponding to the code line submitted by the any submitter; and in response to determining that the fixed line number does not exist in the modified line number, the code fixing for the fixed line number is undid. In this way, code lines submitted by a plurality of authors in the code file are fixed, while it is ensured that the information of the actual modifier of each code line is still correct.

Another embodiment of the present disclosure further provides a code fixing apparatus. FIG. 5 illustrates a schematic block diagram of a code fixing apparatus according to an embodiment of the present disclosure. The apparatus is used for executing the method shown in FIG. 3, and as shown in FIG. 5, the apparatus 500 includes: a first acquisition unit 501, a first fixing unit 502 and a first undo unit 503.

The first acquisition unit 501 is configured to acquire a modified line number corresponding to a modified code line in a first code file submitted.

The first fixing unit 502 is configured to according to an encoding issue existing in the code line corresponding to the modified line number, fix a code in the first code file with the identity of a current submitter of the first code file, and acquire a fixed line number corresponding to the code fixed.

The first undo unit 503 is configured to determine whether the fixed line number is included in the modified line number; and in response to determining that the fixed line number is not included in the modified line number, undo fixing for the fixed line number.

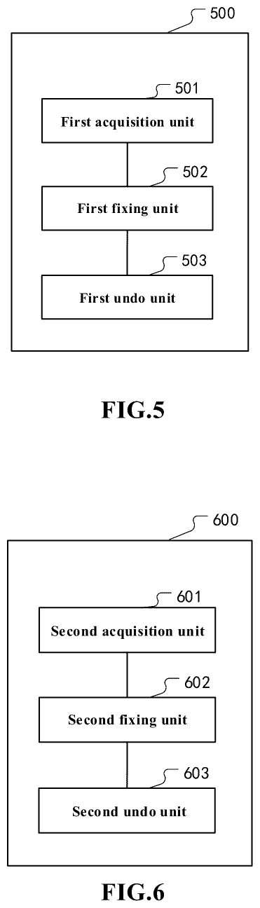

FIG. 6 illustrates a schematic block diagram of a code fixing apparatus according to another embodiment of the present disclosure. The apparatus is used for executing the method shown in FIG. 4, and as shown in FIG. 6, the apparatus 600 includes: a second acquisition unit 601, a second fixing unit 602 and a second undo unit 603.

The second acquisition unit 601 is configured to acquire a submitter corresponding to a target modification in each code line in a second code file.

The second fixing unit 602 is configured to determine an encoding issue existing in a code line submitted by the submitter; according to the encoding issue, fix the code in the second code file with the identity of the submitter, and acquire a fixed line number corresponding to the code fixed; and

The second undo unit 603 is configured to determine whether the fixed line number exists in a modified line number corresponding to each code line submitted by the submitter; and in response to determining that the fixed line number does not exist in the modified line number, undo fixing for the fixed line number.

An embodiment of the present disclosure further provides an electronic device, including a memory and a processor, wherein an executable code is stored in the memory, and the processor implements, when executing the executable code, the method shown in FIG. 3 and FIG. 4.

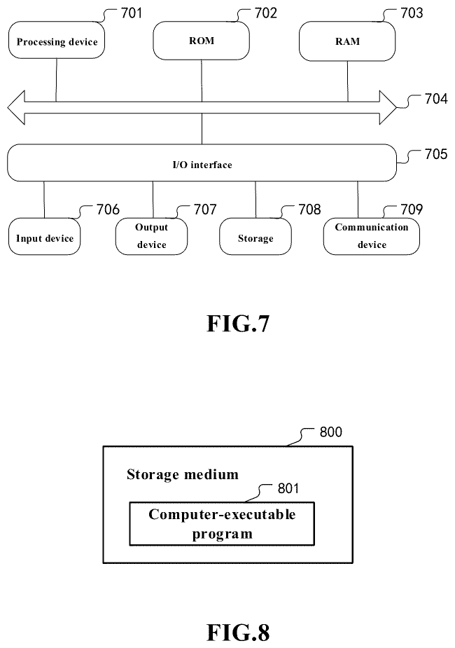

Hereinafter, reference may also be made to FIG. 7, FIG. 7 illustrates a schematic structural diagram of an electronic device 700 suitable for implementing the embodiments of the present application. The electronic device 700 shown in FIG. 7 is merely an example, and should not bring any limitation to the functions and use ranges of the embodiments of the present application.

As shown in FIG. 7, the electronic device 700 may include a processing device (e.g., a central processing unit, a graphics processing unit, or the like) 701. The processing device 701 may be a general-purpose processor, a digital signal processor (DSP), a micro-processor or a micro-controller, and may further include an application specific integrated circuit (ASIC), a field-programmable gate array (FPGA), or other programmable logic devices, a discrete gate or transistor logic device, or a discrete hardware component, and the processing device may execute various suitable actions and processes according to a program stored in a read-only memory (ROM) 702 or a program loaded from a storage device 708 into a random access memory (RAM) 703. In the RAM 703, various programs and data needed by the operations of the electronic device 700 are also stored. The processing device 701, the ROM 702 and the RAM 703 are connected with each other via a bus 704. An input/output (I/O) interface 705 is also connected to the bus 704.

In general, the following device may be connected to the I/O interface 705: an input device 706, including, for example, a touch screen, a touch pad, a keyboard, a mouse, and the like; an output device 707, including, for example, a liquid crystal display (LCD), a speaker, a vibrator, and the like; a storage 708, including, for example, a magnetic tape, a hard disk, and the like; and a communication device 709. The communication device 709 may allow the electronic device 700 to communicate in a wireless or wired manner with other devices to exchange data. Although FIG. 7 illustrates the electronic device 700 having various device, it should be understood that not all illustrated device are required to be implemented or provided. More or fewer device may alternatively be implemented or provided. Each block shown in FIG. 7 may represent one device, and may also represent a plurality of device.

In particular, according to the embodiments of the present application, the processes described above with reference to the flowcharts may be implemented as computer software programs. For example, the embodiments of the present application include a computer program product, which includes a computer program carried on a computer-readable medium, and the computer program contains program codes for executing the method illustrated in the flowcharts. In such embodiments, the computer program may be downloaded and installed from a network via the communication device 709, or installed from the storage 708, or installed from the ROM 702. When the computer program is executed by the processing device 701, the above functions defined in the code fixing method provided in the embodiments of the present application are executed.

An embodiment of the present disclosure further provides a computer-readable storage medium, storing a computer program thereon, wherein when the computer program is executed in a computer, the computer is caused to execute the code fixing method shown in FIG. 1 provided in the embodiments of the present application. FIG. 8 is a schematic diagram of a storage medium for implementing embodiments of the present disclosure. For example, as shown in FIG. 8, the storage medium 800 may be a non-transitory computer-readable storage medium used for storing a non-transitory computer-executable instruction 801. When the non-transitory computer-executable instruction 801 is executed by a processor, the code fixing method provided in the embodiments of the present application may be implemented, for example, when the non-transitory computer-executable instruction 801 is executed by the processor, one or more steps in the code fixing method provided according to the embodiments of the present application may be executed. For example, the storage medium 800 may be applied to the above electronic device, for example, the storage medium 800 may include a memory in the electronic device. Regarding the description of the storage medium 800, reference may be made to the description of the memory in the embodiment of the electronic device, and thus details are not repeated herein again. Regarding specific functions and technical effects of the storage medium 800, reference may be made to the description of the code fixing method provided in the embodiments of the present application, and thus details are not described herein again.

It should be noted that, the computer-readable medium in the embodiments of the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. More specific examples of the computer-readable storage medium may include, but are not limited to: an electrical connection having one or more wires, a storage card of a smart phone, a storage component of a tablet computer, a portable computer magnetic disk, a hard disk of a personal computer, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof. In the embodiments of the present disclosure, the computer-readable storage medium may be any tangible medium that contains or stores a program, wherein the program may be used by or in combination with an instruction execution system, apparatus or device. In the embodiments of the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, RF (radio frequency), and the like, or any suitable combination thereof.

The computer-readable medium may be contained in the above electronic device; and it may also be present separately and is not assembled into the electronic device. The computer-readable medium carries one or more programs that, when executed by a server, cause the electronic device to implement the code fixing method provided in the embodiments of the present application.

Computer program codes for executing the operations of the embodiments of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or the server. In the case involving the remote computer, the remote computer may be connected to the user computer via any type of network, including a local area network (LAN) or a wide area network (WAN), or it may be connected to an external computer (e.g., via the Internet using an Internet service provider).

The flowcharts and block diagrams in the drawings illustrate system architectures, functions and operations of possible implementations of systems, methods and computer program products according to various embodiments of the present disclosure. In this regard, each block in the flowcharts or block diagrams may represent a part of a module, a program segment or a code, and the part of the module, the program segment or the code contains one or more executable instructions for implementing specified logic functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions. The units involved in the described embodiments of the present disclosure may be implemented in a software or hardware manner. The names of the units do not constitute limitations of the units themselves in a certain case. The functions described herein above may be executed, at least in part, by one or more hardware logic components. For example, without limitation, example types of the hardware logic components that may be used include: a field programmable gate array (FPGA), an application specific integrated circuit (ASIC), an application specific standard product (ASSP), a system on chip (SOC), a complex programmable logic device (CPLD), and so on.

Various embodiments in the present specification are all described in a progressive manner, the identical or similar parts between the embodiments refer to each other, and what is highlighted in each embodiment is difference with other embodiments. In particular, for the embodiments of the storage medium and the computing device, they are basically similar to the method embodiments, thus are described simply, and for related parts, reference may be made to some descriptions of the method embodiments.

What have been described above are only preferred embodiments of the present disclosure and illustrations of the technical principles employed. It should be understood by those skilled in the art that, the disclosure scope involved in the preset disclosure is not limited to the technical solutions formed by specific combinations of the above technical features, and meanwhile should also include other technical solutions formed by any combinations of the above technical features or equivalent features thereof without departing from the concept of the disclosure, for example, technical solutions formed by mutual replacement of the above features with technical features having similar functions disclosed in the present disclosure (but is not limited to). In addition, although various operations are described in a particular order, this should not be understood as requiring that these operations are executed in the particular sequence shown or in a sequential order. In certain environments, multitasking and parallel processing may be advantageous. Similarly, although several specific implementation details have been contained in the above discussion, these should not be construed as limiting the scope of the present disclosure. Some features that are described in the context of separate embodiments may also be implemented in combination in a single embodiment. Conversely, various features that are described in the context of a single embodiment may also be implemented in a plurality of embodiments separately or in any suitable sub-combination.

The objectives, technical solutions and beneficial effects of the embodiments of the present invention are further described in detail in the above specific implementations. Although the present theme has been described in language specific to structural features and/or methodological actions, it should be understood that the theme defined in the appended claims is not necessarily limited to the specific features or actions described above. Rather, the specific features and actions described above are merely example forms of implementing the claims. It should be understood that the foregoing descriptions are only specific implementations of the embodiments of the present invention, and are not intended to limit the protection scope of the present invention, and any modifications, equivalent replacements, improvements and the like, made on the basis of the technical solutions of the present invention, shall fall within the protection scope of the present invention.

I/We claim:

1. A code fixing method, comprising:
acquiring a modified line number corresponding to a modified code line in a first code file submitted;
determining an encoding issue existing in the code line corresponding to the modified line number:
according to the encoding issue, fixing a code in the first code file with an identity of a current submitter of the first code file;
acquiring a fixed line number corresponding to the code fixed;
determining whether the fixed line number is included in the modified line number; and
in response to determining that the fixed line number is not included in the modified line number, undoing fixing for the fixed line number.

2. The method according to claim 1, wherein determining the encoding issue existing in the code line corresponding to the modified line number, and according to the encoding issue, fixing a code in the first code file with the identity of the current submitter of the first code file, comprises:
determining an issue line number corresponding to the code line having the encoding issue in the first code file; and
determining whether the issue line number is included in the modified line number; and in response to determining that the issue line number is included in the modified line number, according to the encoding issue existing in the code line corresponding to the issue line number, fixing the code in the first code file with the identity of the current submitter of the first code file.

3. The method according to claim 2, further comprising:
in response to determining that the issue line number is not included in the modified line number, ignoring the encoding issue existing in the code line corresponding to the issue line number.

4. The method according to claim 1, further comprising:
in response to determining that the fixed line number is included in the modified line number, retaining the code fixing for the fixed line number.

5. The method according to claim 1, wherein acquiring the modified line number corresponding to the modified code line in the first code file submitted comprises: acquiring, via a file difference instruction, the modified line number corresponding to the modified code line in the first code file submitted;
wherein determining the issue line number corresponding to the code line having the encoding issue in the first code file comprises: determining, via a code inspection tool, the issue line number corresponding to the code line having the encoding issue in the first code file; and
wherein fixing the code in the first code file comprises: fixing the code in the first code file via an automatic code fixing tool.

6. A code fixing method, comprising:
acquiring a submitter corresponding to a target modification in each code line in a second code file;
determining an encoding issue existing in a code line submitted by the submitter; according to the encoding issue, fixing a code in the second code file with an identity of the submitter, and acquiring a fixed line number corresponding to the code fixed; and
determining whether the fixed line number is included in a modified line number corresponding to the code line submitted by the submitter; and in response to determining that the fixed line number is not included in the modified line number, undoing the code fixing for the fixed line number.

7. The method according to claim 6, wherein acquiring the submitter corresponding to the target modification in each code line in the second code file comprises: acquiring a plurality of submitters corresponding to target modifications in a plurality of code lines in the second code file; and
wherein determining the encoding issue in the code line submitted by the submitter; according to the encoding issue, fixing the code in the second code file with the identity of the submitter, and acquiring the fixed line number corresponding to the code fixed; determining whether the fixed line number is included in the modified line number corresponding to the code line submitted by the submitter; and in response to determining that the fixed line number is not included in the modified line number, undoing the code fixing for the fixed line number, comprises: for any submitter among the plurality of submitters, respectively
determining the encoding issue existing in the code line submitted by the any submitter; according to the encoding issue, fixing the code in the second code file with the identity of the any submitter, and acquiring the fixed line number corresponding to the code fixed; and
determining whether the fixed line number exists in the modified line number corresponding to the code line submitted by the any submitter; and in response to determining that the fixed line number does not exist in the modified line number, undoing the code fixing for the fixed line number.

8. The method according to claim 6, wherein the target modification is a latest modification in each code line in the second code file.

9. A non-transitory computer-readable storage medium, storing a computer program thereon, wherein when the computer program is executed in a computer, the computer is caused to:
acquire a modified line number corresponding to a modified code line in a first code file submitted;
determine an encoding issue existing in the code line corresponding to the modified line number, according to the encoding issue, fix the code in the first code file with an identity of a current submitter of the first code file, and acquire a fixed line number corresponding to the code fixed; and
determine whether the fixed line number is included in the modified line number; and in response to determining that the fixed line number is not included in the modified line number, undo fixing for the fixed line number.

10. The non-transitory computer-readable storage medium according to claim 9, wherein the computer is caused to determine the encoding issue existing in the code line corresponding to the modified line number, and according to the encoding issue, fixing the code in the first code file with the identity of the current submitter of the first code file by being caused to:
determine an issue line number corresponding to the code line having the encoding issue in the first code file; and
determine whether the issue line number is included in the modified line number; and in response to determining that the issue line number is included in the modified line number, according to the encoding issue existing in the code line corresponding to the issue line number, fix the code in the first code file with the identity of the current submitter of the first code file.

11. The non-transitory computer-readable storage medium according to claim 10, wherein the computer is further caused to:
in response to determining that the issue line number is not included in the modified line number, ignore the encoding issue existing in the code line corresponding to the issue line number.

12. The non-transitory computer-readable storage medium according to claim 9, wherein the computer is further caused to:
in response to determining that the fixed line number is included in the modified line number, retain the code fixing for the fixed line number.

13. The non-transitory computer-readable storage medium according to claim 9, wherein the computer is caused to acquire the modified line number corresponding to the modified code line in the first code file submitted by being caused to: acquire, via a file difference instruction, the modified line number corresponding to the modified code line in the first code file submitted;
wherein the computer is caused to determine the issue line number corresponding to the code line having the encoding issue in the first code file by being caused to: determine, via a code inspection tool, the issue line number corresponding to the code line having the encoding issue in the first code file; and
wherein the computer is caused to fix the code in the first code file by being caused to: fix the code in the first code file via an automatic code fixing tool.

14. A non-transitory computer-readable storage medium, storing a computer program thereon, wherein when the computer program is executed in a computer, the computer is caused to:
acquire a submitter corresponding to a target modification in each code line in a second code file;
determine an encoding issue existing in a code line submitted by the submitter; according to the encoding issue, fix a code in the second code file with an identity of the submitter, and acquire a fixed line number corresponding to the code fixed; and
determine whether the fixed line number is included in a modified line number corresponding to the code line submitted by the submitter; and in response to determining that the fixed line number is not included in the modified line number, undo fixing for the fixed line number.

15. The non-transitory computer-readable storage medium according to claim 14, wherein the computer is caused to: acquire the submitter corresponding to the target modification in each code line in the second code file by being caused to: acquire a plurality of submitters corresponding to target modifications in a plurality of code lines in the second code file; and
wherein the computer is caused to determine the encoding issue in the code line submitted by the submitter; according to the encoding issue, fix the code in the second code file with the identity of the submitter, and acquire the fixed line number corresponding to the code fixed; determine whether the fixed line number is included in the modified line number corresponding to the code line submitted by the submitter; and in response to determining that the fixed line number is not included in the modified line number, undo fixing for the fixed line number, being caused to: for any submitter among the plurality of submitters, respectively
determine the encoding issue existing in the code line submitted by the any submitter; according to the encoding issue, fix the code in the second code file with the identity of the any submitter, and acquire the fixed line number corresponding to the code fixed; and
determine whether the fixed line number exists in the modified line number corresponding to the code line submitted by the any submitter; and in response to determining that the fixed line number does not exist in the modified line number, undo fixing for the fixed line number.

16. The non-transitory computer-readable storage medium according to claim 14, wherein the target modification is a latest modification in each code line in the second code file.

17. An computer device, comprising: a memory and a processor, wherein an executable code is stored in the memory, and the processor implements, when executing the executable code, the method according to claim 1.

18. An computer device, comprising: a memory and a processor, wherein an executable code is stored in the memory, and the processor implements, when executing the executable code, the method according to claim 6.
